(19) United States
(12) Patent Application Publication
(10) Pub. No.: US 2009/0106271 A1
(43) Pub. Date: Apr. 23, 2009

(54) SECURE SEARCH OF PRIVATE DOCUMENTS IN AN ENTERPRISE CONTENT MANAGEMENT SYSTEM

(75) Inventors: Trieu C. Chieu, Scarsdale, NY (US); Thao N. Nguyen, Katonah, NY (US); Liangzhao Zeng, Mohegan Lake, NY (US)

Correspondence Address: GEORGE A. WILLINGHAN, III;AUGUST LAW, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 11/875,087

(22) Filed: Oct. 19, 2007

(51) Int. Cl. G06F 17/00

(52) U.S. Cl. 707/100; 707/E17.008

(57) ABSTRACT

An enterprise content management system such as an electronic contract system manages a large number of secure documents for many organizations. The search of these private documents for different organizational users with role-based access control is a challenging task. A content-based extensible mark-up language (XML)-annotated secure-index search mechanism is provided that provides an effective search and retrieval of private documents with document-level security. The search mechanism includes a document analysis framework for text analysis and annotation, a search indexer to build and incorporate document access control information directly into a search index, an XML-based search engine, and a compound query generation technique to join user role and organization information into search query. By incorporating document access information directly into the search index and combining user information in the search query, search and retrieval of private contract documents can be achieved very effectively and securely with high performance.

### FIELD OF THE INVENTION

The present invention relates to document management systems.

### BACKGROUND OF THE INVENTION

An enterprise content management system such as an electronic contract system manages a large number of secure documents for many organizations. Traditionally, in a large enterprise, a large number of contracts are created, executed and managed daily via a paper-based process that involves a number of manual steps for reviewing, approving and signing these contracts. However, this manual contracting process is inefficient, cumbersome, costly and time consuming. Standardized processes do not exist, and convenient access to relevant or related contracts and documents is lacking. Automation of the contract lifecycle management presents a substantial value creation opportunity for the enterprise. Increase value is found in accelerated contract lifecycle processes, improved productivity, reduced costs, and minimized potential contractual errors and faults, as well as better compliance enforcement.

With the proliferation of Internet technology and electronic commerce, enterprises are adopting online electronic contracting processes to streamline the contracting process. There are many research activities and implementation efforts in these enterprise electronic contract management systems that deal with contract creation and document lifecycle management. In general, the lifecycle of an electronic contract for enterprises incorporates a large number of private collateral documents such as the master and customer agreements, supplements and addenda among others. Security settings are associated with each one of these collateral documents to grant or deny access to these documents to organizational users based on the identity of rile of a particular user and the defined policies of the involved contracting parties. Given a large number of documents and a large number of users, the search, retrieval and access management the documents is a challenging task.

Search and retrieval of the documents are performed using keyword-based search mechanisms. Keyword-based searches rely on keywords and meta-data that describe and classify the essential topic and characteristics of each document. Typically, meta-data are captured and recorded along with the document at the time of document creation. Full-text searching provides a wider search scope by allowing the search of document content that matches identified keywords. A more advanced search mechanism is semantic search. Semantic searching allows the search principle based on higher-level concepts, semantic relationships between words and the contexts in which the words occur inside a document. Although these search mechanisms provide different advanced capabilities for the search of documents, both lack the ability to address the security and access control of the private documents for an enterprise content management system.

Current applications of enterprise search systems based on the keyword and semantic search mechanisms return search results as a list of matching document links to the users. When a user selects a link, the original document is retrieved and displayed on the client machine. For a secure document, the fetching system performs authentication by requesting an identification and password from the user to verify the access rights before retrieving the document. Although this authentication mechanism may protect the unauthorized access of secure documents, this mechanism may not be able to prevent the unintentional exposure of sensitive business information to unauthorized users.

Therefore, a secure document search technique is desired that can effectively hide the existence of highly sensitive and private documents from unauthorized users in order to protect business confidentiality. One obvious technique to support this type of secure search is post-filtering. However, post-filtering techniques typically require extra processing time to perform filtering at query time. Therefore, end users may be subjected to lower performance and slower response.

### SUMMARY OF THE INVENTION

Systems and methods in accordance with the present invention utilize a content-based extensible mark-up language (XML)-annotated secure-index search mechanism for the effective search and retrieval of only authorized private documents with document-level security for an enterprise content management system. A document analysis framework is provided to parse documents into text for analysis and annotation, and a search indexer is utilized that is able to incorporate the access-control information of the source documents directly into the secure search-index. A compound query generation mechanism is provided that joins user profile information into each search query in order to effectively retrieve only the authorized documents.

The document analysis framework is developed based on an open source

Unstructured Information Management Architecture (LJIMA) [12-15] infrastructure that provides a number of basic building blocks for implementing analysis engines and annotators in order to analyze and annotate meta-data in a document. Examples of this infrastructure can be found in UIMA Framework, http://uima-ramework.sourceforge.net/, D. Ferrucci and A. Lally, Building an Example Application with the Unstructured Information Management Architecture, IBM Systems Journal, Vol. 43, No. 3, 2004, pp. 445-475, D. Ferrucci and A. Lally, UIMA: An Architecture Approach to Unstructured Information Processing in the Corporate Research Environment, Natural Language Engineering, 2004 and A. Levas, E. Brown, J. W. Murdock, and D. Ferrucci, The Semantic Analysis Workbench (SAW): Towards a Framework for Knowledge Gathering and Synthesis, Proc. 2005 Int 7 Conference on Intelligence Analysis, McLean, Va., 2-6 May, 2005. A number of primitive and meta-data annotators are created using this framework including an access control annotator that captures the document security settings. The annotations discovered by the annotators are then incorporated directly into a secure search-index by the search indexer. To effectively utilize the secure search-index to search for authorized documents, a compound query generation mechanism is also incorporated in the search client to join the user profile information in the search query.

In accordance with one exemplary embodiment, the present invention is directed to a method for secure document management in which a document index is established that includes a plurality of index entries for a plurality of documents. Each index entry corresponds to one of the plurality of documents and includes both content information and security requirements for that document. In addition, each index entry contains content information comprises keywords extracted from the corresponding document and meta-data created using extracted content from the corresponding document. In one embodiment, establishing the document index for each one of the plurality of documents includes retrieving the document from a document database, identifying keywords in the retrieved document, analyzing the retrieved document to create meta-data annotations and creating a corresponding index entry for the retrieved document comprising the identified keywords and the created meta-data annotations. In order to analyze the retrieved document to create the meta-data annotations, at least one primitive annotator is used to analyze and to extract content from the retrieved document, and at least one meta-data annotator is used to built meta-data annotations as composites of the extracted content from the primitive annotator. This extracted content includes tokens, words, dates, time patterns and combinations thereof. In one embodiment, establishing the document index for each one of the plurality of documents includes identifying the security requirements governing document access and incorporating the identified security requirements into each index entry. Incorporation of the identified security requirements includes using an access-control annotator to annotate the security requirements into each index entry.

Having established the document index, a content-based query from a requesting party along with a security status for the requesting party are identified. Identification of the content-based query from a requesting party and a security status for the requesting party further includes identifying a content-based query from the requesting party, identifying a security status for the requesting party and creating a combined query using the identified content-based query and the identified security status. The documents corresponding to index entries containing content information satisfying the content-based query and security requirements satisfied by the security status of the requesting party associated with the content-based query are retrieved. These security requirements include a list of requestors granted access to the corresponding document, a list of requestor authority levels granted access to the corresponding document, a list of organizations to which requesters granted access to the corresponding documents may belong, time constraints, date constraints, security codes and combinations thereof. In one embodiment, retrieving the documents includes submitting the identified content-based query and the identified security status to an index search engine and using the index search engine to search the document index. Preferably, the index search engine is an extensible mark-up language search engine.

The present invention is also directed to a document management system that includes a plurality of documents stored in electronic format in one or more databases and a document index containing a plurality of index entries. Each index entry corresponding to one of the plurality of documents and includes content information and security requirements for that document. The document management system also includes a search engine in communication with the document index to search the document index in response to requester queries. Each requester query includes a content-based query and a security status for a requesting party associated with that requester query. A document collection processing engine is included that is capable of retrieving each one of the plurality of documents, associating content information and security requirements with each retrieved document and creating an index entry comprising the associated content information and security requirements. Preferably, the search engine comprises an extensible mark-up language search engine.

In one embodiment, the content information includes keywords, meta-data and combinations thereof. The security requirements include a list of requestors granted access to the corresponding document, a list of requester authority levels granted access to the corresponding document, a list of organizations to which requestors granted access to the corresponding documents may belong, time constraints, date constraints, security codes and combinations thereof. In one embodiment, the document collection processing engine includes an aggregate text analysis engine to analyze each document, to create meta-data and to identify security requirements for association with each document. In one embodiment, the aggregate text analysis engine includes primitive annotators to analyze and to extract primitive data from each document, meta-data annotators to build composite annotations using the extracted primitive data and a security requirements annotator to create security requirements for each document.

### BRIEF DESCRIPTION OF THE DRAWINGS

FIG. 1 is a block diagram representation of an architecture of an enterprise content management system for use in accordance with the present invention;

FIG. 2 is a block diagram of an embodiment of a document search component for use in document management systems in accordance with the present invention; and

FIG. 3 is a block diagram of an embodiment of a document collection processing engine for use in a document management system in accordance with the present invention.

### DETAILED DESCRIPTION

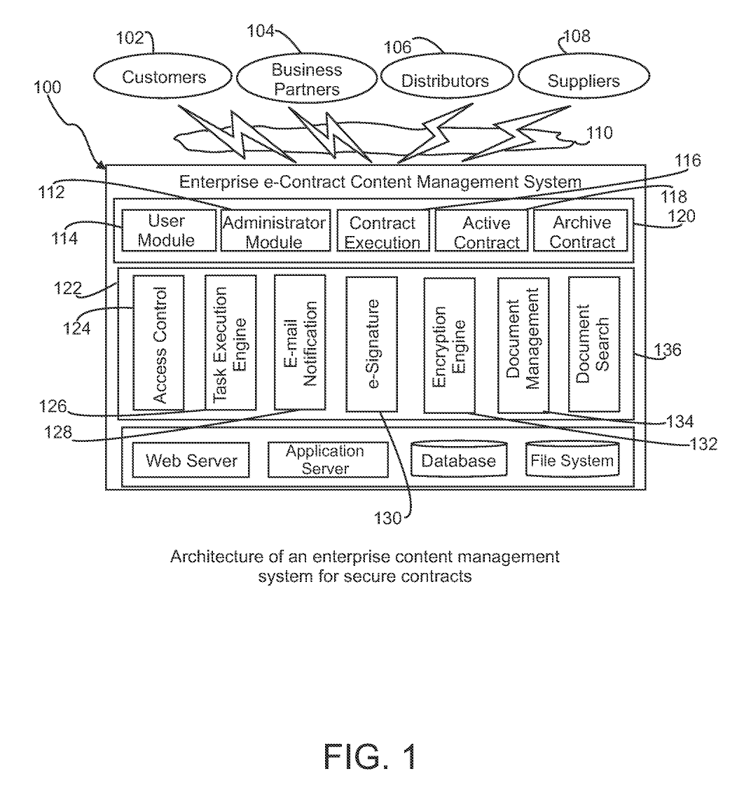

Referring initially to FIG. 1, an exemplary embodiment of the architecture of an enterprise content management system 100 to support the secure management of documents, for example documents used in contracting process, across multiple enterprise organizations in accordance with the present invention is illustrated. In general, systems and methods in accordance with the present invention can be used to provide for the management and searching of any type of document that is created and stored in an electronic, machine readable format. In one embodiment, the enterprise content management system is constructed as an enterprise web application serviced by a host contracting organization. The system can be accessed by registered users of all organizations including customers 102, business partners 104, distributors 106 and suppliers 108. The registered users contact the system across one of more networks including wide area networks such as the Internet and local area networks.

In an embodiment where the documents are used in support of a contracting process, the enterprise content management system includes an administrator module 112, a user module 114, a contract execution module 116, an active contract module 118 and an archive contract module 120. These modules are supported by a plurality of core components 122 including an access control component 124, an encryption engine 132, an e-signature engine 130, a task execution engine 126 for document workflows, an e-mail notification component 128, a document management component 134 and a document search component 136.

The administrator module 112 can be accessed by a number of different administrators to perform various administrative functions depending on the particular role provided by a given administrator. In one embodiment, the roles of the organization administrators are assigned by a system administrator of the host organization, and user roles of individual organizations can be assigned by their respective organizational administrators. A plurality of users, each designated to perform the same or different predefined tasks on an electronic contract, can access simultaneously their user modules 114. The access control component 124 is responsible for enforcing the security of the system by authenticating and authorizing the user's rights of accessing the system and performing a specific task on a given document. The task execution engine 126 is responsible for the transition and recording of the state of a given document after a task is executed and includes a document flow engine that routes documents to users based on the assigned process flow and the resulting state of the document. The e-mail notification component 128 is responsible for sending e-mail notifications to users in the involved parties along the execution steps of the document flows. The e-signature engine 130 is used to record the digital signature of users for signing a document. The encryption engine 132 is used to encrypt and to protect the content of documents. The document management component 134 is responsible for the organization, tracking, and storage of documents in the database and file system. Finally, the document search component 136 is used to provide the lookup and retrieval capabilities of secure documents for users.

During the contract lifecycle management process, many documents relevant to the contract transaction are added and attached to the transaction by contracting party users. Since the contracting parties may have different relationships depending on the given contract process, the added collateral documents may have different security or access control requirements that specify which users from which contracting party can have access to a given document, for example based on the role that a given user is providing. Since every user in the electronic document management system may be involved in a large number of contract transactions or may be trying to access a variety of documents at any given time, enterprise content management systems in accordance with the present invention provide document search functions to facilitate the lookup and retrieval of the secure transactions and contract documents. In one embodiment, document search and retrieval in accordance with the present invention utilizes a full-text content-based extensible mark-up language (XML)-annotated secure-index search component.

Traditional keyword-based search engines work on an index of tokens or words that make up a given document, processing queries as Boolean combinations of tokens. The result of the traditionally processed query is a ranked list of documents that contain the combinations of tokens specified in the query. In accordance with embodiments of the present invention, the XML-annotated search scans a document for concepts specified by meta-data annotations in the document content in addition to searching for keywords within a given document. Therefore, the corresponding search engine, which is preferably an XML-based search engine, requires the capability to support the basic elements and Boolean operators such as ‘+’ and ‘−’. In addition, the XML-based search engine handles queries based on not just keywords that appear in the documents but also any concept derived in the text by the applied analysis engines. The XML-based search engine utilizes a search engine indexer that indexes tokens as well as annotations resulting from the applied analysis engines.

To specify the concepts and the attributes of the concepts within a search query, the XML search engine supports XML-based query syntax. For example, if a document contains the text “IBM”, which appears as part of a phrase annotated as a supplier by a named-entity data tag, and is indexed with an annotation called “Supplier”, the document can be retrieved by the search engine using the XML annotated tag “<Supplier>” as specified in:
“<Supplier>IBM</Supplier>”

In general, the XML search engine supports both keyword and annotated syntax. A search query using the XML search engine contains both regular keywords and XML queries. These query components can be combined using suitable Boolean search operator including “+” and “−”. Examples of suitable queries containing XML tags include, but are not limited to, the following.

‘<Document-Type>Master Agreement</Document_Type>’ to find documents with document type of “Master Agreement”
‘+computer+<Date>I/\/2007</Date>’ to find documents that contain both a keyword “computer” and an annotated date of “Jan. 1, 2007”
‘+<Document_Type>Master Agreement</Document Type>+<Supplier>IBM </Supplier>+<Contract_Start_Date> 1/1/2007</Contract_Start_Date>’ to find documents of type “Master Agreement” that contain both a supplier of “IBM” and a contract start date of “Jan. 1, 2007”.

Queries using this format work effectively when the meta-data annotators have been executed on documents to identify annotations having named-entities, for example “Document type”, “Supplier”, “Date” and “Contract Start Date”. In addition, these queries utilize a searchable document index built to include a plurality of index entry for a plurality of documents where each index entry includes content information that incorporates these meta-data annotations and key words for a corresponding document.

In order to provide for secure document search with document-level security, i.e., documents are not even retrieved or presented to a requester absent the appropriate level of security status in the requesting party, annotations specifying the security requirements for control of access to each document are created and incorporated into the index entries for the documents. Suitable security requirements include, but are not limited to, a list of requesters or users that are granted access to a given document, a list of requester authority levels, i.e., the roles that a given requester fulfills within a particular organization, a list of organizations or domains to which requestors granted access to the corresponding documents may belong, time constraints, data constraints, security codes, e.g., passwords, and combinations thereof. For example, for secure documents with authority level or role-based access control policies that specify which user role in which organization can access a given private document, the corresponding pairs of user authority or user role and organization name are aggregated to form new access control tokens to be annotated with a special named-entity such as “Access_Role_Party”. For a secure document that is accessible by users having the associated authority or rile of either reviewer or signer for an organization identified as “XYZ”, the tokens “Reviewer XYZ” and “Signer XYZ” are created and annotated as “Access_Role_Party” annotations. These annotations are incorporated into the index entry by a suitable indexer to support a secure index search using a search engine such as the XML search engine.

To enable secure searching by users of the document management systems of the present invention, each identified document query by a user or requester includes a content-based query and a security status for the requester associated with the query. In one embodiment, a content-based query, that is a query based on the content of the document including keywords and meta-data, is combined with a security status of the requester or user submitting the query. These two elements are combined or converted into a compound query that joins the user request with the user security status, e.g., role and organization information. This compound search is then submitted to a search engine that is capable of searching the index entries in the document index. In one embodiment, the security status attributes for a given user or requester can be combined into an aggregate security status. For example, the user role and organization name are aggregated to form an access control token. In one embodiment, creation of the security status of a user is handled using methods similar to the creation of document meta-data annotations during the retrieval and analysis of each document. In an embodiment where the security status of the requested is the aggregated user role and organization name, this aggregated security status is encapsulated with the XML tag <Access_Role_Party>, either separately or in the compound query with the content-based query. For example, to search for all documents which include a supplier of “IBM” and a contract start date of “1/1/2007” in the system by a signer of organization “XYZ”, the content-based query of ‘+<Supplier>IBM</Supplier>+<Contract_Start_Date>1/1/2007</Contract_Start_Date>’ is combined with the security status into a compound search query of ‘+<Supplier>IBM</Supplier>+<Contract_Start_Date>1/1/2007</Contract_Start_Date>+<Access_Role_Party>Signer_XYZ</Access_Role_Party>’.

This compound query specifies a document index search for all documents that contain a supplier of “IBM”, a contract start date of “1/1/2007” and an “Access_Role_Party” annotation of “Signer_XYZ” in the index entry for that document. Documents having index entries that do not contain the “Access_Role_Party” annotation of ‘Signer_XYZ’ are automatically eliminated by the search engine for this search request, thus signifying a very effective and secure search mechanism.

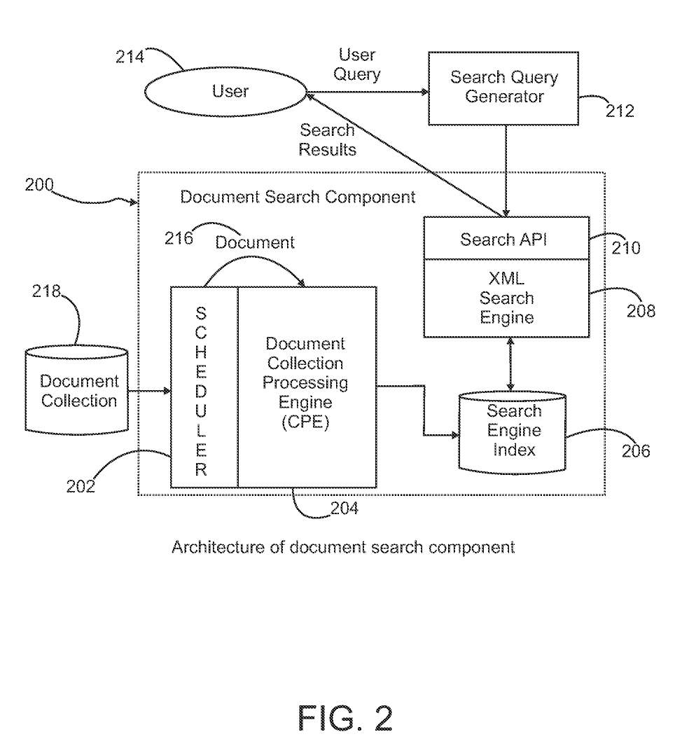

Referring to FIG. 2, an exemplary embodiment of the architecture of a document search component for search of secure documents 200 in accordance with the present invention is illustrated. The document search component includes a software scheduler service 202 and a document collection processing engine (CPE) 204 in communication with the software scheduler service. The CPE utilizes a Juru indexer, which is described in D. Carmel, E. Amittay, M. Herscovici, Y. S. Maarek, Y. Petruschka and A. Soffer, Juru at TREC 10—Experiments with Index Pruning, Proc. 10th Text Retrieval Conference (TREC-10), National Institute of Standards and Technology, NIST, 2001. The document search component also includes a file repository for the search index 206 in communication with the document collection processing engine and a XML-based Juru search engine 208 that includes a search application programming interface (API) 210. The XML-based Juru search engine is also described in Carmel et al. The search API facilitates the communication of queries from a search query generator 212 and the reporting of the results of the query to a user 214. In one embodiment, the search query generator is a compound search query generator.

The scheduler schedules and starts the processing tasks of the document CPE at predefined intervals. The scheduler communicates a document 216 to the CPE that the scheduler has retrieved from a document collection database 218. The CPE parses, analyzes and indexes the contents of the communicated document. The parsed text and analysis results of a given document are then indexed and stored in the repository database 206 as a searchable index entry that can be accessed and read by the search engine. Indexing or the creation of an index entry for inclusion in the document index is conducted for each one of a plurality of documents and can be repeated over time as documents are added to the database, removed from the database or edited. The Juru indexer and the Juru XML-based search engine are utilized to meet the query and indexing requirements for the XML-annotated search. The document index built using the Juru indexer provides a very efficient lookup and retrieval index for the search engine. In one embodiment, the document index is created by first mapping words, tokens and terms parsed in a given document to the document itself and then compressing and storing these mappings in inverted file format. In addition, the searchable document index is made aware of all the annotations that are extracted by the annotators in the analysis phase. To specify the concepts and attributes of the concepts within a given user-defined query, the Juru search engine introduces a query language called XML fragments, which is described in D. Carmel, Y. Maarek, M. Manderbrod, Y. Mass and A. Soffer, Searching XML Documents via XML Fragments, Proc. 26th Annual International ACMSIGIR Conference on Research and Development in Information Retrieval, ACM, 2003, Toronto, Canada, 2003. This query language utilizes the meta-data annotations incorporated in the searchable document index. The search query generator generates combined queries that combine content-based queries with the security status information of the user.

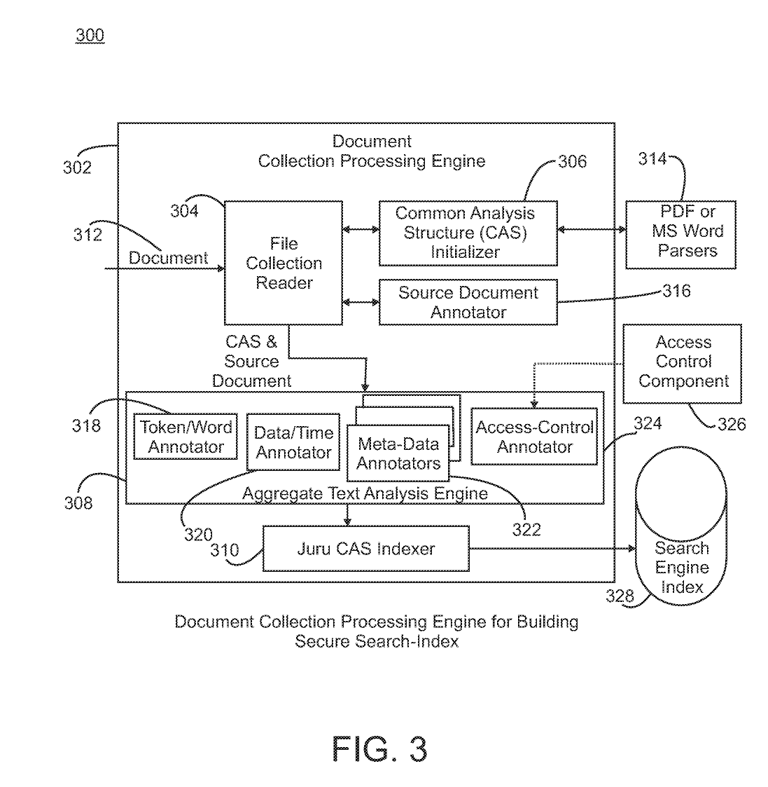

Referring to FIG. 3, an exemplary embodiment of the parsing, analysis and indexing of the documents carried by the document CPE is illustrated. The document CPE 302 includes a file collection reader 304, a parser initializer 306, a plurality of primitive text analysis engines (TAEs) 308 and a Juru indexer 310. In one embodiment, the CPE is constructed based on an open source Unstructured Information Management Architecture (UIMA) framework, which is described in UIMA Framework, http://uima-framework.sourceforge.net/, D. Ferrucci and A. Lally, Building an Example Application with the Unstructured Information Management Architecture, IBM Systems Journal, Vol. 43, No. 3, pp. 445-475 (2004), D. Ferrucci and A. Lally, UIMA: An Architecture Approach to Unstructured Information Processing in the Corporate Research Environment, Natural Language Engineering (2004) and A. Levas, E. Brown, J. W. Murdock, and D. Ferrucci, The Semantic Analysis Workbench (SAW): Towards a Framework for Knowledge Gathering and Synthesis, Proc. 2005 Int 7 Conference on Intelligence Analysis, McLean, Va., 2-6 May 2005. The execution of the CPE is orchestrated and managed by the UIMA framework through its CPE component descriptor. Any number of analysis engines can be configured and plugged into the framework for analysis using the descriptor files.

The UIMA is a software architecture and component infrastructure for supporting the discovery, composition and deployment of multi-modal analysis technologies for unstructured information and their integration with structured information sources. It utilizes the basic building blocks called analysis engines (AEs) to analyze a document. Analysis engines receive analysis results from other components and produce new results that include their own contributions. An analysis engine works on a common analysis structure (CAS) that incorporates the original data, the generated indexes and meta-data and the output of analysis from other engines. All results of an analysis engine are contained in the CAS that can be used by the invoking application. An analysis engine can be a single engine or a composite of several engines. An analysis engine that works on text is called a text analysis engine (TAB). At the heart of AEs are components called annotators that implement the particular functions to perform analysis algorithms in order to analyze documents and record analysis results as meta-data or annotations. These analysis results include, for example, detecting a contract start date and a contract end date. In general, an annotator takes a document as input and outputs its analysis as meta-data. The meta-data described concepts embedded in the original document. In one embodiment, a single annotator is used to analyze a document. Alternatively, a plurality of annotators is used arranged in either a serial or parallel arrangement. In one embodiment a plurality of annotators arranged as a chain is used to examine each document and any associated meta-data and to produce additional meta-data as annotations as results of their analysis. In general, an analysis engine may contain any number of annotators. In the case of a TAE, the analysis function may be tokenization, categorization, named-entity extraction or language detection. Annotators are given a CAS Object, i.e., Java Object, holding the subject of analysis (the document), in addition to any previously created objects, and they add their own objects to the CAS Object. After the analysis engines add their information to the CAS Object, the CAS consumers will perform the final CAS processing. For example, a CAS consumer can extract elements of interest and populate a relational database or a CAS indexer consumer can index the CAS contents for a search engine.

Referring to the document CPE illustrated in FIG. 3, the file collection reader 304 is responsible for collecting newly added or recently edited private documents 312 from the management system, fetching the next document, and invoking a CAS initializer 306 to initialize a CAS object with the document content. To parse the source document into text format for analysis, the CAS initializer checks the file type and invokes the corresponding PDF or MS Word parser 314. In addition, a source document annotator 316 initialized with annotations that encapsulate the original document source meta-data information is added to the CAS object for downstream processing. The source meta-data are available at the time of document creation or upload to the system. This source document information typically includes the original uniform resource identifier (URI) of the document, the file name and size, the information about the owner or creator of the document and other relevant meta-data describing the source and properties of the document.

To enable content-based XML-annotated searches with the desired level of document-level security, the aggregate text analysis engine 308 includes a token/word annotator 318, a date/time annotator 320, a plurality of meta-data annotators 322 and an access-control, i.e., security requirements, annotator 324. The token/word and date/time annotators are primitive annotators used to analyze and extract primitive data from the document such as token, word, date, and time patterns. The meta-data annotators are used to build composite annotations based on the primitive data extracted by the primitive annotators. The following are some examples of meta-data named-entities to be extracted and annotated by the system:

“Contract Document Type” to specify the contract document types such as Master Agreement, Customer Agreement, Term Lease Supplement and Statement for Services among others

### “Contract Number”, “Agreement Number”, “Contract Value”.

### “Customer Name Address”, “Service Provider Name Address”, “Distributor Name Address”, “Supplier Name Address”

### “Contract Start Date”, “Contract End Date”, “Submission Date”, “Valid Through Date”

The access-control or security requirements annotator is in communication with an access control component 326 of the system architecture and annotates the corresponding access information of the source document and includes this information into CAS object for indexing. The Juru CAS Indexer 310 builds the searchable document index containing a plurality of index entries for the plurality of documents. Each index entry includes the security requirements for an associated document. The document index containing the plurality of index entries is stored the searchable index repository database 328. This secure searchable document index is available to search engines such as the XML-based Juru search engine 208 (FIG. 2) for document search and retrieval.

As used herein, the various annotators are the primary components of the text analysis engine that are used to perform the analysis algorithm. The result of the analysis is an annotation that associates data patterns with the start and end positions of those patterns within the document text. This information is added to the CAS object and is available for use downstream. Thus, for a multiple annotator chain, the annotator next in the chain uses the information developed by the previous annotators in the chain for further analysis. In one exemplary embodiment of the present invention, a plurality of primitive annotators is used. These primitive annotators include, but are not limited to, the token/word and date/time annotators at the beginning of the text analysis engine chain. Both of these primitive annotators implement the simple matching of character, string and word patterns using the regular expressions in Java. An example of a regular expression to match the short date patterns in month, day and optional year format is given as follows:

“(?s)\\b((Jan\Feb\Mar\Apr\May\Jun\Jul\Aug\Sep\Sept\Oct\Nov\Dec)\\.?\\s[0-3]?\\d(((,\\s+)?[1-2]\\d\\d\\d)\((,\\s+)?\\d\\d))?)\\W”

To support a document index search using meta-data, a plurality of document meta-data annotators is used. These annotators are complex annotators that perform text analysis to detect the meta-data based on the annotation results from the primitive annotators. For example, to annotate a contract start date in a contract document, the contract start date annotator first scans the document to find matches for the data tag “contract start date”. Once a section of text starting with data tag is identified, the first appearance of a date annotation within the fixed span of text is then extracted. This date annotation is assigned as the annotation for the contract start date and is added to the CAS object for incorporating into the search index.

To support an effective document search with the desired level of security, the security requirements annotator is included in the aggregated text analysis engine. The security requirements annotator is used to annotate the document with security requirements that are incorporated into the index entry for the document. The document security requirements are developed based on pre-defined or user-defined access control rules for document-level security in the enterprise content management system. A typical document-level security requirement specifies access rules based on an identification of the user roles in a given organization that can access a given private document. Therefore, a corresponding named-entity of “Access_Role_Party” is used to capture and annotate this security requirement.

For example, for a document security requirement specifying that only ‘administrator’, ‘creator’ or ‘approvers’ of organization ‘ABC’, and ‘administrator’ or ‘signers’ of organization ‘XYZ’ can access a given document, the following “Access_Role_Party” annotations will be created and associated with the index entry for that document.
‘Administrator_ABC’, ‘Creator_ABC’, ‘Approver_ABC’ for organization ‘ABC’ ‘Administrator_XYZ’, ‘Signer_XYZ’ for organization ‘XYZ’.
   With these annotations incorporated into the searchable document index, a secure search is carried out readily from the search engine by joining the user and organization information in the content-based queries that include keywords and meta-data. Only those private documents that a user serving in a specified role within a given organization has access to are returned.

### EXAMPLES

Experiments were conducted using a Juru indexer, a Juru XML-based search engine and a search client in a low-end Windows XP workstation with a 2.16 GHz CPU, 2 GB of RAM and a Java Runtime. A first experimental setup parsed and indexed a plurality of private documents without incorporating security requirements in the search index. Instead, a post-filtering, i.e., post-search, loop using the access control settings of each document was applied to the search results to eliminate the unauthorized documents in the search client. The second experimental utilized the secure-index search mechanism of the enterprise content management system of the present invention. The document security requirements were incorporated into the secure document index, and a compound search query generation technique was implemented in the search client to join user security status in the content-based search query.

The experimental results for secure document search using both experimental setups on an IBM pilot electronic contract system are summarized in Table 1. The search is performed on a total number of approximately 22,500 private contract documents in the system with 1,090 registered organizations. Each user, e.g., administrator, was selected from several contracting organizations to submit a number of common search keywords, e.g., “IBM”, “Hardware”, and “Server”, to search and retrieve matched and authorized documents. The chosen contracting organizations represented either a large organization, e.g., Org. J, that has created a large number of contracts, a medium organization, e.g. Org. M, that has created medium number of contracts or small organizations, e.g., Org. C, Org. A, that have created smaller numbers of contracts in the system. To investigate the performance of both experimental setups, the keywords, the organizations of the selected user, the numbers of matched documents (before applying document access control security), the numbers of authorized documents (after considering document access control security) and the response times for post-filtering technique (Resp. Time with Post-Filtering) and for secure-index search technique (Resp. Time with Secure-Index) were recorded. The response time value was taken as an average value of 10 different runs. In addition, the ratio of the response times (Resp. Time Ratio) to examine the relative performance of these experiments was calculated.

TABLE I
Experimental results for secure document search on a pilot electronic
contract system

| | | | | | Resp. | |
|---|---|---|---|---|---|---|
| | | | | Resp. | Time | |
| | | | | Time | with | |
| | User | Number of | | with Post- | Secure- | Resp. |
| Search | Organ- | Matched/Authorized | | Filtering | Index | Time |
| Keyword | ization | Documents (Ratio) | | (msecs) | (msecs) | Ratio |
| IBM | Org. J | 13,372/4,231 | (3.2) | 14,178 | 4,720 | 3 |
| IBM | Org. M | 13,372/791 | (16.9) | 14,392 | 1,248 | 11.5 |
| IBM | Org. C | 13,372/70 | (191.0) | 13,652 | 483 | 28.2 |
| Hardware | Org. J | 3,002/1,571 | (1.9) | 2,924 | 1,736 | 1.7 |
| Hardware | Org. M | 3,002/68 | (44.1) | 2,904 | 186 | 15.6 |
| Hardware | Org. C | 3,002/12 | (250.2) | 2,876 | 95 | 30.2 |
| Server | Org. J | 1,510/268 | (5.6) | 1,470 | 411 | 3.6 |
| Server | Org. M | 1,510/15 | (100.7) | 1,496 | 99 | 15.1 |
| Server | Org. C | 1,510/8 | (188.8) | 1,474 | 52 | 23.5 |
| Server | Org. A | 1,510/2 | (755) | 1,460 | 47 | 27.9 |

In the case of the search keyword of “IBM”, the system actually contained a total of 13,372 matched documents without concerning security. As illustrated in Table 1, after applying the document access control rules corresponding to an administrator of Org. J, the number of documents reduced to 4,231. The first experiment took a total of 14.178 seconds to retrieve and filter the result lists while the second experiment only took 4.720 seconds to retrieve the same authorized documents, thus providing a factor of 3× improvement in response time. In other cases, substantial reductions in response times with improvement factors ranging from 10× to 30× were observed for the second secure-index search experiment.

The smaller response times consistently recorded for the secure-index search mechanism of the present invention indicate that the incorporation of document access information directly into the secure search-index is more efficient than the search system that uses a post-filtering technique for processing document security. When the number of authorized documents is small while the number of raw keyword-matched documents is large, the secure-index search mechanism significantly outperforms the post-filtering search approach, which has to spend more time to process the larger number of documents.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for secure document management in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for secure document management, the method comprising:
establishing a document index comprising a plurality of index entries for a plurality of documents, each index entry corresponding to one of the plurality of documents and comprising content information and security requirements for that document;
identifying a content-based query from a requesting party and a security status for the requesting party; and
retrieving documents corresponding to index entries comprising content information satisfying the content-based query and security requirements satisfied by the security status of the requesting party associated with the content-based query.

2. The method of claim 1, wherein the index entry content information comprises keywords extracted from the corresponding document.

3. The method of claim 1, wherein the index entry content information comprises meta-data created using extracted content from the corresponding document.

4. The method of claim 1, wherein the security requirements comprise a list of requesters granted access to the corresponding document, a list of requestor authority levels granted access to the corresponding document, a list of organizations to which requestors granted access to the corresponding documents may belong, time constraints, date constraints, security codes or combinations thereof.

5. The method of claim 1, wherein the step of establishing the document index for each one of the plurality of documents further comprises:
retrieving the document from a document database;
identifying keywords in the retrieved document;
analyzing the retrieved document to create meta-data annotations; and
creating a corresponding index entry for the retrieved document comprising the identified keywords and the created meta-data annotations.

6. The method of claim 5, wherein the step of analyzing the retrieved document to create the meta-data annotations further comprises:
using at least one primitive annotator to analyze and to extract content from the retrieved document; and
using at least one meta-data annotator to built meta-data annotations as composites of the extracted content from the primitive annotator.

7. The method of claim 6, wherein the extracted content comprises tokens, words, dates, time patterns or combinations thereof.

8. The method of claim 1, wherein the step of establishing the document index for each one of the plurality of documents further comprises:
identifying the security requirements governing document access; and
incorporating the identified security requirements into each index entry.

9. The method of claim 8, wherein the step of incorporating the identified security requirements further comprises using an access-control annotator to annotate the security requirements into each index entry.

10. The method of claim 1, wherein the step of identifying a content-based query from a requesting party and a security status for the requesting party further comprises:
identifying a content-based query from the requesting party;
identifying a security status for the requesting party; and
creating a combined query using the identified content-based query and the identified security status.

11. The method of claim 1, wherein the step of retrieving the documents further comprises:
submitting the identified content-based query and the identified security status to an index search engine; and
using the index search engine to search the document index.

12. The method of claim 11, wherein the index search engine comprises an extensible mark-up language search engine.

13. A document management system comprising:
a plurality of documents;
a document index comprising a plurality of index entries, each index entry corresponding to one of the plurality of documents and comprising content information and security requirements for that document;
a search engine in communication with the document index to search the document index in response to requester queries, each requester query comprising a content-based query and a security status for a requesting party associated with that requester query; and
a document collection processing engine capable of retrieving each one of the plurality of documents, associating content information and security requirements with each retrieved document and creating an index entry comprising the associated content information and security requirements.

14. The document management system of claim 13, wherein the search engine comprises an extensible mark-up language search engine.

15. The document management system of claim 13, wherein the content information comprises keywords, meta-data or combinations thereof.

16. The document management system of claim 13, wherein the security requirements comprise a list of requestors granted access to the corresponding document, a list of requestor authority levels granted access to the corresponding document, a list of organizations to which requesters granted access to the corresponding documents may belong, time constraints, date constraints, security codes or combinations thereof.

17. The document management system of claim 13, wherein the document collection processing engine comprises an aggregate text analysis engine to analyze each document, to create meta-data and to identify security requirements for association with each document.

18. The document management system of claim 17, wherein the aggregate text analysis engine comprises:
primitive annotators to analyze and to extract primitive data from each document;
meta-data annotators to build composite annotations using the extracted primitive data; and
a security requirements annotator to create security requirements for each document.

19. A computer-readable medium containing a computer-readable code that when read by a computer causes the computer to perform a method for secure document management, the method comprising:
establishing a document index comprising a plurality of index entries for a plurality of documents, each index entry corresponding to one of the plurality of documents and comprising content information and security requirements for that document;
identifying a content-based query from a requesting party and a security status for the requesting party; and
retrieving documents corresponding to index entries comprising content information satisfying the content-based query and security requirements satisfied by the security status of the requesting party associated with the content-based query.

20. The computer-readable medium of claim 19, wherein the security requirements comprise a list of requesters granted access to the corresponding document, a list of requester authority levels granted access to the corresponding document, a list of organizations to which requesters granted access to the corresponding documents may belong, time constraints, date constraints, security codes or combinations thereof.
